(19) United States
(12) Patent Application Publication
(10) Pub. No.: US 2009/0208076 A1
(43) Pub. Date: Aug. 20, 2009

(54) MEDICAL NETWORK SYSTEM, AND IMAGE-INTERPRETATION SUPPORT APPARATUS AND METHOD

(75) Inventors: Toshiaki Nakajima, Minato-ku (JP); Masaru Asakawa, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/371,200

(22) Filed: Feb. 13, 2009

(30) Foreign Application Priority Data
Feb. 14, 2008 (JP) 2008-032901

(51) Int. Cl. G06K 9/00

(52) U.S. Cl. 382/128

(57) ABSTRACT

Even though a client hospital has made an urgent image-interpretation request, if a designated radiologist is out of an image-interpretation center, a data center transfers the request to a portable terminal of the radiologist. Upon receiving the urgent request, the radiologist accesses the data center to download an image to be interpreted. An application server in the data center forms a whole image by subjecting the original image to a data amount reduction process, and delivers it to the portable terminal. The application server also forms a detailed image by cropping a desired area out of the original image, and delivers it to the portable terminal if necessary. The detailed image has higher resolution than the whole image because it is not subjected to the data amount reduction process. The radiologist makes a medical report with observing the image by the portable terminal and uploads it to the data center.

### BACKGROUND OF THE INVENTION

1. Field of the Invention

The present invention relates to a medical network system for supporting interpretation of medical images, and an image-interpretation support apparatus and method.

2. Description Related to the Prior Art

A medical network system which provides online application services using computer systems is known, such as an automated reservation service for accepting reservations for medical examinations carried out in a plurality of medical facilities and an image-interpretation support service for supporting a diagnosis (interpretation) of medical images (refer to U.S. Patent Application Publication No. 2005/0228697). In such a medical network system, a computer system in a data center as a service provider is interconnected to computer systems set up in a plurality of medical facilities through a wide-area network (WAN) such as a wide-area IP (internet protocol) network, a public telephone network and leased lines.

In such an image-interpretation support service, the data center receives an image-interpretation request from a medical facility as a client, and sends application data to an image-interpretation center having radiologists. The radiologist interprets medical images in accordance with the application data and reports its result to the client.

In medical practice, there are many cases of requiring an urgent image-interpretation, and the image-interpretation center needs a system to meet such an urgent request anytime. However, the image-interpretation center could not always meet the urgent request due to a shortage of radiologists on a holiday and at night or the absence of a radiologist designated by the client (for example, a radiologist who has taken charge of the same case in the past).

To solve the foregoing problem, Japanese Patent Laid-Open Publication No. 2006-024048 discloses a computer system which delivers medical images to be interpreted to a portable terminal (like a cellular phone) of a radiologist. The radiologist can receive and interpret the medical images by the portable terminal, and hence the medical practice has large expectations for the computer system.

A commercial portable terminal such as a cellular phone, however, is of inferior hardware performance such as CPU processing capability and memory capacity as compared with a personal computer or workstation. Accordingly, there is a problem that the portable terminal has too little processing capability to display a large data sized image such as a medical image. A shortage of processing capability causes long display processing time such as time for waiting until a medical image appears, switching among a plurality of medical images and zooming in on a specific part of the medical image.

Image-interpretation heavily uses screen operation such as switching among a plurality of medical images for a comparison purpose and zooming in on a concerned area of the image. Thus, a shortage of processing capability hinders the image-interpretation. To solve this problem, it is conceivable to produce an interpretation-specific high-performance portable terminal a radiologist can carry, but this idea is not practical in view of cost.

As another solution, it is conceivable to uniformly lower the resolution of every medical image by data compression for the purpose of reducing the data amount of the medical images delivered to a portable terminal. Image-interpretation, however, often needs to verify a subtle shade by enlarging a minute portion. Accordingly, simply lowering the resolution of every medical image in a uniform manner interferes with verification, resulting in misinterpretation.

### SUMMARY OF THE INVENTION

An object of the present invention is to provide an image-interpretation support apparatus and method which enable a radiologist to smoothly interpret medical images by using an inexpensive portable terminal with relatively low processing capability.

To achieve the foregoing object, an image-interpretation support apparatus according to the present invention comprises an image obtaining device for obtaining data of the medical image from image storage; a first image forming device for forming a first image by reducing the data amount of the medical image; a second image forming device for forming a second image having higher resolution than the first image by cropping an area corresponding to a part of the first image out of the medical image; and a delivery device for delivering the first image and the second image to the portable terminal.

It is preferable that a field of the first image is the same as that of the medical image.

The delivery device may deliver a list of a plurality of medical images to the portable terminal, and then deliver the first image of the medical image chosen from the list to the portable terminal.

In the list, the medical image which is desired to be interpreted prior to the other ones may be marked with a distinction mark.

It is preferable that the delivery device delivers display screen creation data for displaying at least one of the first image, the second image and the medical image list on a screen of the portable terminal.

The display screen creation data may include an asynchronous communication program run on the portable terminal to issue a delivery request of the second image asynchronously to an input of an operational command to the portable terminal.

The asynchronous communication program may issue a delivery request of an image peripheral to the second image displayed on the screen of the portable terminal.

The delivery device may deliver report edit screen creation data for displaying a report edit screen of a medical report on the screen of the portable terminal.

It is preferable that the image-interpretation support apparatus further comprises a report format conversion device. The report format conversion device receives data of the medical report inputted in the report edit screen and converts a format of the medical report into a predetermined report format.

In the report edit screen, a text-entry field for inputting text and an image display field for displaying the first image or the second image may be displayed in a tiled manner.

The report edit screen may have a graphic user interface for switching between a tiled display mode and a text-entry field display mode. In the tiled display mode, both of the text-entry field and the image display field are displayed in a tiled manner. In the text-entry field display mode, the text-entry field is displayed by itself.

A method for supporting an interpretation of a medical image according to the present invention comprises the steps of: obtaining data of the medical image from image storage; forming a first image by reducing the data amount of the medical image; forming a second image having higher resolution than the first image by cropping an area corresponding a part of the first image out of the medical image; and delivering the first image and the second image to a portable terminal.

A medical network system according to the present invention has a first computer system as an interpretation client of a medical image and a second computer system communicatably connected to the first computer system via a network for delivering the medical image received from the first computer system to a portable terminal. The second computer system comprises an image obtaining device for obtaining data of the medical image from the first computer system; a first image forming device for forming a first image by reducing the data amount of the medical image; a second image forming device for forming a second image having higher resolution than the first image by cropping an area corresponding to a part of the first image out of the medical image; and a delivery device for delivering the first image and the second image to the portable terminal.

It is preferable that the second computer system further comprises a notification device for notifying the portable terminal about an image-interpretation request accepted from the first computer system.

The notification device may notify a request contact different from the portable terminal about the image-interpretation request before notifying the portable terminal, and then notify the portable terminal about the image-interpretation request on the basis of a response result from the request contact.

According to the present invention, the first image and the second image are delivered to the portable terminal. The first image is formed by reducing the data amount of the medical image. The second image has a field of a part of the first image which is enlarged with high resolution. Therefore, it is possible to smoothly interpret the medical image even with the use of the inexpensive portable terminal with relatively low processing capability.

### BRIEF DESCRIPTION OF THE DRAWINGS

For more complete understanding of the present invention, and the advantage thereof, reference is now made to the following descriptions taken in conjunction with the accompanying drawings, in which:

FIG. 1 is a schematic view showing the structure of a medical network system;

FIG. 2 is an explanatory view of data stored in a center database server;

FIG. 3 is a block diagram showing the structure of an application server;

FIG. 4 is an explanatory view showing a process flow of a request processing section;

FIG. 5 is an explanatory view showing a process flow of the request processing section and an image processing section;

FIG. 6 is an explanatory view of screen creation data;

FIG. 7 is a schematic view showing display screens generated by the screen creation data;

FIG. 8 is an explanatory view of a detailed image display process;

FIG. 9 is a schematic view showing edit screens generated by the screen creation data;

FIG. 10 is a flowchart showing the procedure of making an image-interpretation request and reports; and

FIG. 11 is a flowchart showing the procedure of determining an image process condition on the basis of the model of a portable terminal.

### DESCRIPTION OF THE PREFERRED EMBODIMENTS

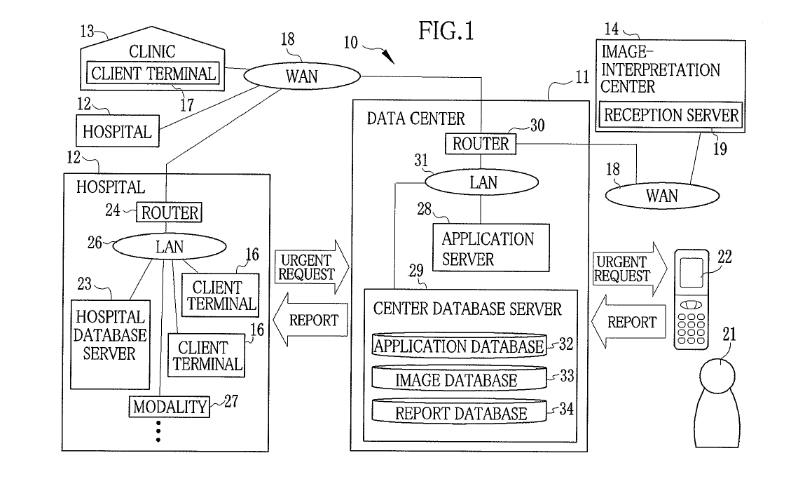

A medical network system 10 shown in FIG. 1 is composed of a computer system of a data center 11, computer systems set up in medical facilities such as hospitals 12 and a clinic 13, and a computer system of an image-interpretation center 14. The computer system of the data center 11 is interconnected to the computer systems of the hospitals 12, the clinic 13 and the image-interpretation center 14 through a communication network.

The hospital 12 is a relatively large-scale medical facility in its area, and has sophisticated medical examination apparatuses (modalities) such as CT (computed tomography) and MRI (magnetic resonance imaging). The hospital 12 accepts a medical request such as an examination request from outside medical facilities. The clinic 13 is a relatively small-scale medical facility and does not have such modalities. As for a disease demanding an examination by the modality, the clinic 13 commits medical diagnosis and treatment to the hospital 12. The hospital 12 accepts a medical request from the clinic 13 via the data center 11. The image-interpretation center 14 accepts the interpretation of a medical image (hereinafter simply called image) in response to a request from the hospital 12 or clinic 13. The image-interpretation center 14 has radiologists 21 specializing in image-interpretation.

The computer system of the data center 11 is communicatable with client terminals 16 of the hospital 12 and a client terminal 17 of the clinic 13 through a WAN (wide area network) 18. The computer system of the data center 11 is also interconnected to a reception server 19 and a client terminal (not illustrated) of the image-interpretation center 14.

The data center 11 provides application services such as an examination reservation support service and an image-interpretation support service in response to a request from the client terminals 16 and 17. In the individual client terminals 16 and 17, browser software corresponding to, for example, HTTP (hypertext transfer protocol) is installed. The client terminals 16 and 17 get the application services by communicating with the computer system of the data center 11.

In the examination reservation support service, schedule data of the hospital 12 is sent to the client terminal 17 of the clinic 13, and a reservation of a medical examination is accepted from the clinic 13 and sent to the hospital 12. The schedule data is displayed in, for example, calendar format on the client terminal 17. A patient of the clinic 13 checks vacancy in a displayed schedule and makes a reservation at the hospital 12. Reservation data is sent from the client terminal 17 to a hospital database server 23 of the hospital 12 via the data center 11.

The image-interpretation support service supports a medical image interpretation which the hospital 12 requests of the image-interpretation center 14. The data center 11 accepts application data and a medical image to be interpreted, and transfers them to the image-interpretation center 14.

In spite of the fact that a client has made an urgent image-interpretation request, when a radiologist 21 designated by the client is absent from the image-interpretation center 14 or the image-interpretation center 14 is lacking in radiologists 21, the data center 11 transfers notification of the urgent request to a portable terminal 22 of the radiologist 21 outside the center 14. In receiving the notification with the portable terminal 22, the radiologist 21 accesses the data center 11 to download the image to be interpreted. The radiologist 21 makes a medical report (hereinafter simply called report) with observing the image on a screen of the portable terminal 22, and uploads the report to the data center 11. The data center 11 sends the uploaded report to the client.

The WAN 18 is a wide area network such as a wide area IP (internet protocol) network, a public telephone network and leased lines. As the WAN 18 interconnecting the data center 11 to the hospitals 12, the clinic 13 and the image-interpretation center 14, for example, a VPN (virtual private network), which virtually builds private lines on a shared network such as the IP network and the Internet provided by a communication common carrier, is used in view of both information security and communication cost. On the other hand, for example, the Internet is used in the communication between the portable terminal 22 of the radiologist 21 and the data center 11.

The computer system of the hospital 12 is composed of a plurality of client terminals 16 and the hospital database server 23. The computer system is connected to the WAN 18 through a router 24. The client terminals 16 include diagnosis and treatment department terminals set up in each department of medical practice such as surgery and medicine, information management terminals set up in each examination department such as radiology and endoscopy and a network access terminal for uploading application and image data to the image-interpretation center 14.

The client terminals 16 are communicatable with one another via a LAN (local area network) 26 within the hospital 12, and carry out communication by email and the like. The client terminals 16 are accessible to the hospital database server 23 via the LAN 26. To the LAN 26, is also connected a plurality of modalities 27. Images taken by the modality 27 are sent to the hospital database server 23 through the LAN 26 and stored therein.

To build the hospital database server 23, for example, a DBMS (database management system) is installed on a workstation. The hospital database server 23 manages various databases such as a medical chart database storing patients' medical chart data and an examination database storing examination data. The examination data includes numerical data, electrocardiograms and the like obtained by physiological examinations and laboratory tests in addition to images taken by the modalities 27. In the hospital database server 23, data is stored on or retrieved from the corresponding database in response to a request from the client terminal 16.

The router 24 transfers data between different types of networks such as the LAN 26 within the hospital 12 and the WAN 18. The router 24 has a LAN port connected to the LAN 26 and a WAN port connected to the WAN 18.

The computer system of the data center 11 is composed of an application server 28, a center database server 29 and a router 30 which are communicatably connected via a LAN 31. The router 30, which is identical to the router 24, transfers data between the LAN 31 and the WAN 18. The application server 28 provides the examination reservation support service and the image-interpretation support service.

To build the center database server 29, for example, the DBMS is installed on a workstation as with the hospital database server 23. The center database server 29 manages an application database 32 for storing reservation data and image-interpretation application data accepted from the hospitals 12 and the clinic 13, an image database 33 for storing image data to be interpreted sent from the hospitals 12 and a report database 34 for storing report data sent from the image-interpretation center 14 and the portable terminal 22. In the center database server 29, data is stored on or retrieved from the corresponding database in response to a request from the application server 28.

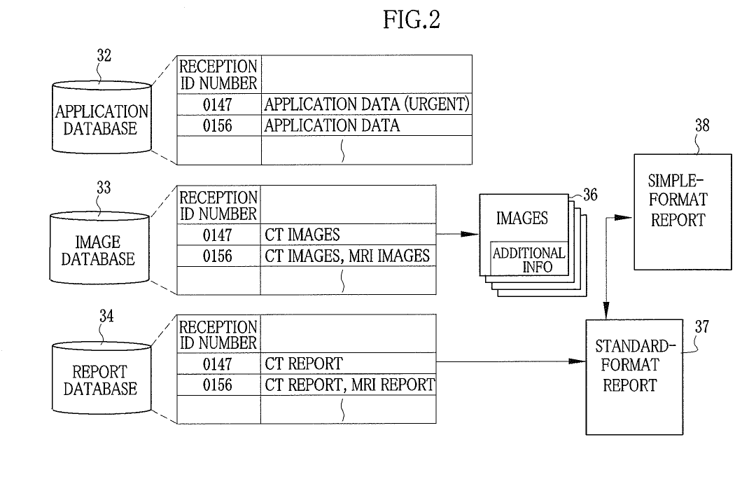

As shown in FIG. 2, each image-interpretation request is provided with a reception ID number, and application data is stored on a request basis in the application database 32. The application data includes a plurality of items such as the name and ID number of a client, the name and ID number of a request contact designated by the client, a textual format request, basic patient information (the name and ID number of a patient, a birthday, age and sex), an annotation, and the name and ID number of a radiologist if the client has designated one. The annotation includes, for example, the ID number of an image which the client wants the radiologist to interpret with particular attention (prior to the other images) in diagnosis and information about a concerned area (body part and lesion) in the image. In the case of an urgent request, the application data includes urgent designation.

In the image database 33, the data of images 36 to be interpreted is stored with respect to its reception ID number. When volume data having a series of images (tomographic images) such as CT images and MRI images is to be interpreted, a matching process is carried out such as storing the series of images in a single folder and creating a table for matching plural image ID numbers to the single reception ID number. Every image data has additional information such as a DICOM (digital imaging and communications in medicine) tag. The additional information has a field for recording an examination parameter like an imaging condition and the basic patient information such as the name, ID number and sex of a patient.

In the report database 34, the data of a standard-format report 37 and a simple-format report 38 is stored. The standard-format report 37 is a report made in a standard documentary format. The standard documentary format is applied to report data transferred among the data center 11, the image-interpretation center 14 and the hospital 12. The simple-format report 38 is a report made in a simple documentary format. The simple documentary format is applied to report data transferred from the portable terminal 22 to the data center 11.

The simple-format report 38 has less decoration and a smaller data amount than the standard-format report 37. As described hereinafter, the data center 11 creates the standard-format report 37 out of the simple-format report 38 sent from the portable terminal 22 by report format conversion, and delivers this standard-format report 37 to the client. The report database 34 stores the standard-format report 37 and the simple-format report 38 on the same request with respect to the common reception ID number.

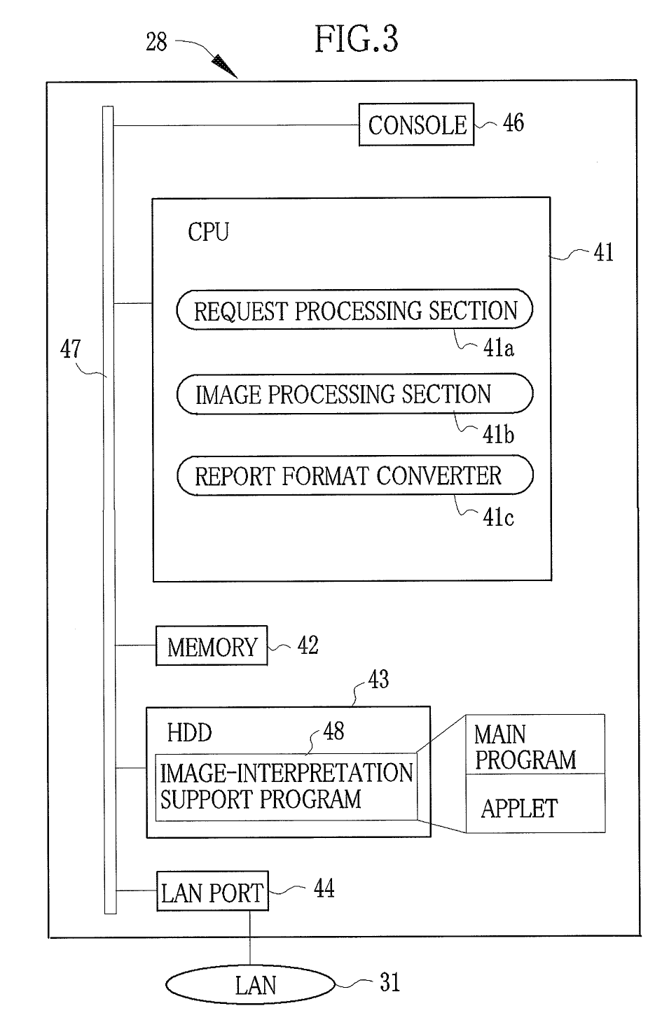

Referring to FIG. 3, the application server 28 is a computer such as a workstation and a personal computer on which server application software such as an operating system, an examination reservation support program (not illustrated) and an image-interpretation support program 48 is installed.

The application server 28 is provided with a CPU 41, a memory 42, a HDD (hard disk drive) 43, a LAN port 44 and a console 46 which are connected via a data bus 47. The console 46 is composed of a monitor and an input device including a keyboard and a mouse. An administrator uses the console 46 in managing and setting up the application server 28.

The HDD 43 stores various programs such as the operating system and image-interpretation support program 48 running on the CPU 41. The image-interpretation support program 48 is composed of a main program and applets described later on.

The memory 42 is a working memory used by the CPU 41 for carrying out processes. The CPU 41 loads the program stored on the HDD 43 and executes processes written in the program so as to overall control every part of the application server 28. The LAN port 44 is a network interface for controlling data transfer from/to the LAN 31.

By running the image-interpretation support program 48, the CPU 41 functions as a request processing section 41a, an image processing section 41b and a report format converter 41c. The request processing section 41a corresponds to an image obtaining section, a delivery section and a notification section of the present invention. The image processing section 41b corresponds to a first image generator and second image generator of the present invention.

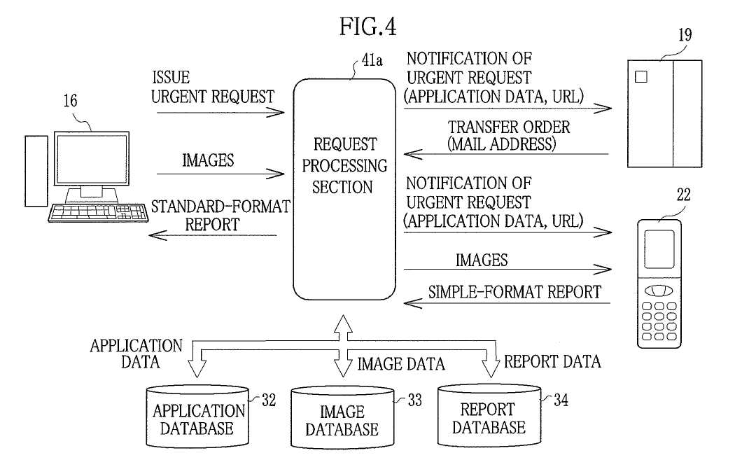

As shown in FIG. 4, the request processing section 41a accepts access from the client terminal 16 of the hospital 12 being an image-interpretation client and from the reception server 19 of the image-interpretation center 14 and the portable terminal 22 being request contacts, and processes requests issued from each of them. Upon obtaining application data and images 36 from the client terminal 16, the request processing section 41a accesses the center database server 29 to store the application data in the application database 32 and the images 36 in the image database 33.

The request processing section 41a makes a request notification in, for example, an e-mail package containing the accepted application data and the URL (uniform resource locator) of an image delivery site for delivering the images 36 in the image database 33, and sends it to the reception server 19 of the image-interpretation center 14. A staff member of the image-interpretation center 14 checks the request notification, which is received by the reception server 19, with a terminal connected to the reception server 19. Then, the staff member accesses the URL of the image delivery site of the data center 11 from the terminal via the reception server 19 to issue a delivery request of the images 36 to be interpreted to the request processing section 41a. Upon receiving the image delivery request from the reception server 19, the request processing section 41a reads the images 36 out of the image database 33 and delivers them to the reception server 19.

In the case of an urgent image-interpretation request, the client terminal 16 adds urgent designation to the application data. Receiving a request notification with the urgent designation (urgent request notification), a clerk of the image-interpretation center 14 checks the schedule of every radiologist, and judges whether or not a radiologist staff 21 in the image-interpretation center 14 can deal with the request. If yes, the clerk accesses the URL of the image delivery site from the terminal via the reception server 19 to download the images 36. If the radiologist staff 21 in the image-interpretation center 14 cannot deal with the request because the radiologist 21 designated by the client is out of office due to some reason such as a holiday and business trip, the clerk sends a transfer order to the data center 11 via the reception server 19 with a mail address of the portable terminal 22 the radiologist 21 has.

In response to the transfer order from the reception server 19, the request processing section 41a sends an urgent request notification to the mail address described in the transfer order. The urgent request notification sent to the portable terminal 22 includes the URL of an image delivery site for the portable terminal 22. Upon receiving the urgent request notification by the portable terminal 22, the radiologist 21 accesses the URL of the image delivery site described in the notification and downloads the images 36. The radiologist 21 observes the received images 36 and carries out an image-interpretation with the use of the portable terminal 22. Then, the radiologist 21 inputs an image-interpretation result to the portable terminal 22, so that the result is compiled into the simple-format report 38 and then the data of the simple-format report 38 is uploaded to the data center 11. Upon receiving the simple-format report 38 from the portable terminal 22, the request processing section 41a stores it in the report database 34 with the reception ID number corresponding to that case.

After storing the simple-format report 38, the request processing section 41a orders the report format converter 41c to carry out a conversion process. The report format converter 41c converts the simple-format report 38 into the standard-format report 37, and stores the standard-format report 37 in the report database 34 in association with the simple-format report 38. When the standard-format report 37 has been stored, the request processing section 41a sends a report completion notification to the client terminal 16 of the hospital 12 as the client. The report completion notification includes a storage location address (URL) of the standard-format report 37, so that the client terminal 16 accesses the URL and issues a report delivery request. In response to the request, the request processing section 41a delivers the standard-format report 37 to the client terminal 16.

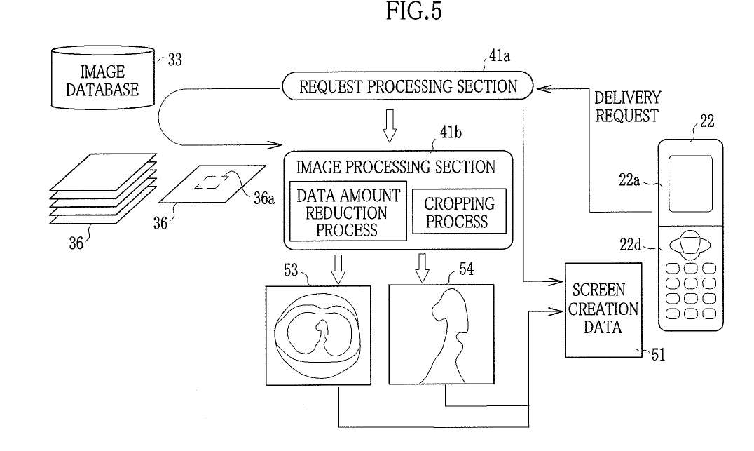

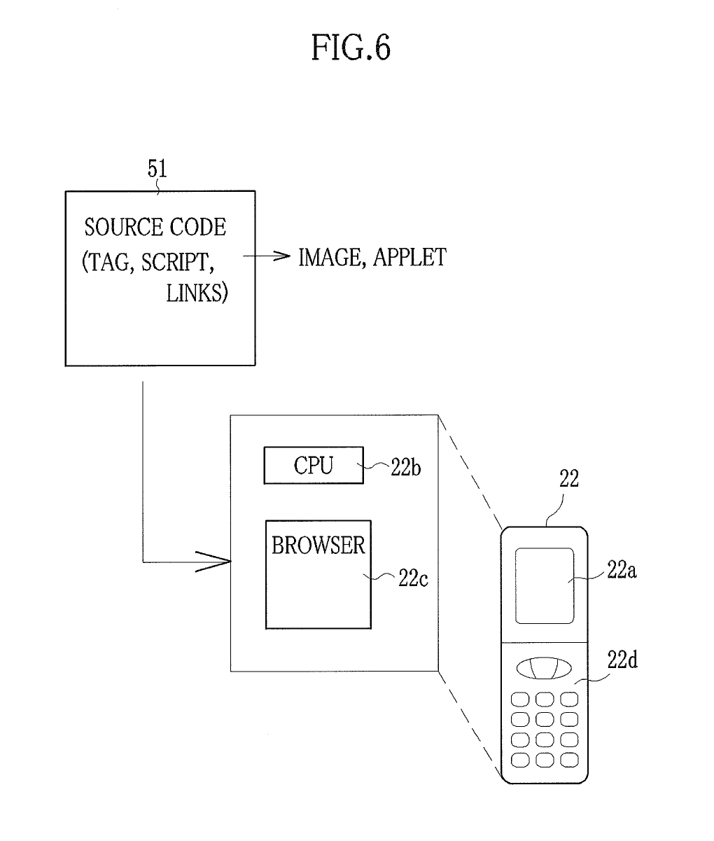

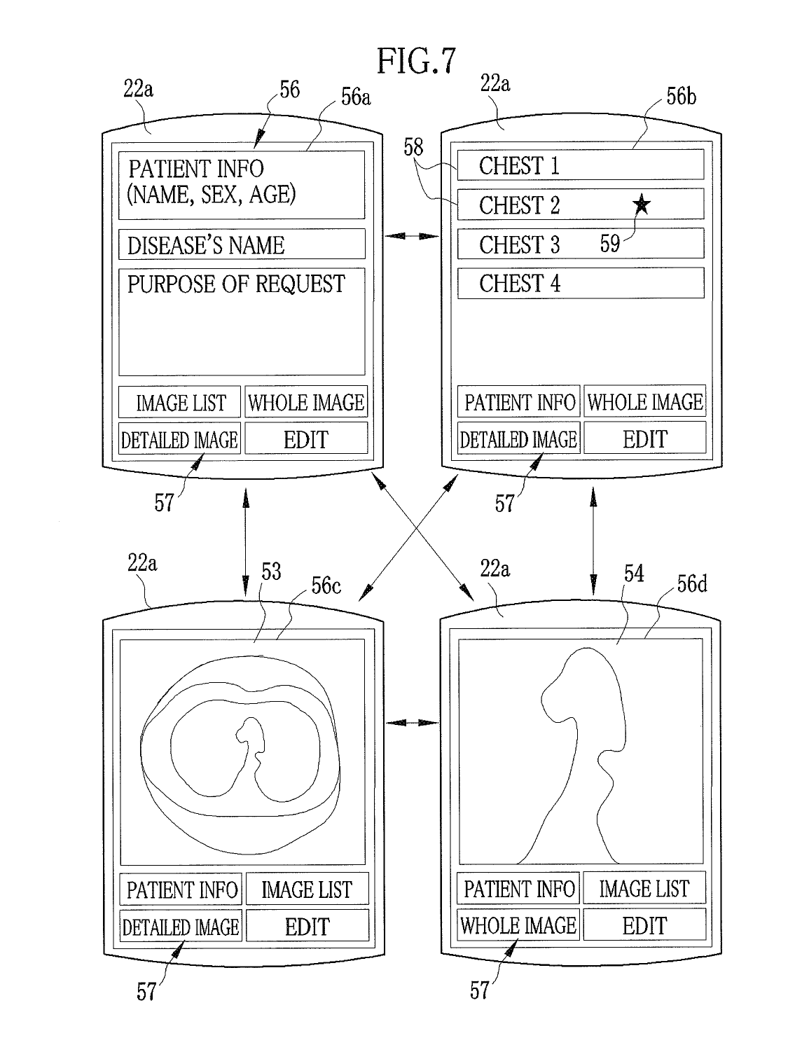

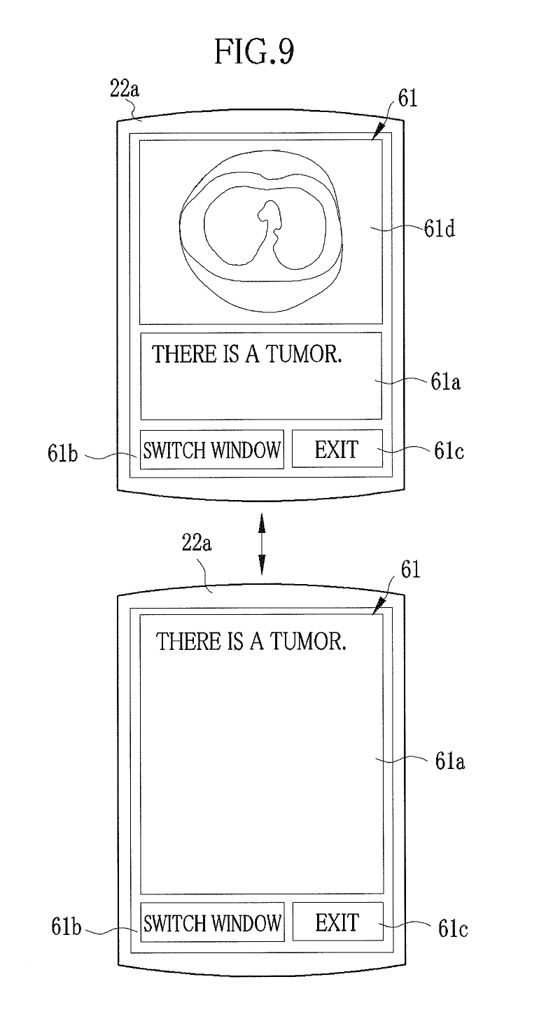

As shown in FIGS. 5 and 6, the request processing section 41a provides screen creation data 51 to the portable terminal 22 in a HTTP-compliant procedure. The screen creation data 51 includes display screen creation data and report edit screen creation data. The screen creation data 51 creates a display screen 56 (refer to FIG. 7) for displaying the medical images 36 and a report edit screen 61 (refer to FIG. 9) for editing the simple-format report 38 on a screen 22a of the portable terminal 22. The screen creation data 51 is Web page data in which source code is written in a WWW (World Wide Web)-compliant hyper text markup language such as an XML (extensible markup language).

As shown in FIG. 6, the portable terminal 22 has a CPU 22b. A browser 22c is installed on the portable terminal 22, and the CPU 22b runs the browser 22c. The browser 22c generates the display screen 56 (refer to FIG. 7) and the report edit screen 61 (refer to FIG. 9) on the screen 22a of the portable terminal 22 by analyzing and running the source code of the received screen creation data 51. The browser 22c is a typical browser installed on, for example, a commercial cellular phone.

The source code includes a command group such as tags and scripts which indicates orders and a process procedure to the browser 22c. The command group defines a screen configuration including an image display field, an edit field, a GUI (graphical user interface) such as operation buttons and the color, size and layout thereof in the display screen 56 and the report edit screen 61.

The source code also includes links to the image data and application data, being the contents of the screen creation data 51, and links to applets. The request processing section 41a writes a storage location address of the medical images 36 stored in the image database 33 on the screen creation data 51 as the link. The browser 22c issues a delivery request of the linked contents to the request processing section 41a, lays out the delivered contents on the display screen 56 and displays them on the screen 22a. The applet which is a short application program run by the browser 22c is delivered from the request processing section 41a as necessary. The request processing section 41a provides an asynchronous communication program for speeding up a display process of the images 36 as an applet. The applet is stored in, for example, the HDD 43 together with the main program of the image-interpretation support program 48 (refer to FIG. 3).

As shown in FIG. 5, upon receiving a delivery request of the image 36 from the portable terminal 22, the request processing section 41a reads the original data of the chosen single image 36 out of the image database 33 of the center database server 29, and orders the image processing section 41b to carry out an image process. The original data refers to the data of the images 36 stored in a provider which has provided it to the request processing section 41a, and particularly in this embodiment, refers to the data of the medical images 36 received from the client and stored in the image database 33.

The image processing section 41b carries out a data amount reduction process for reducing the amount of original data and an image cropping process for cropping a part of the original data. In the data amount reduction process, the original data is subjected to a data compression process or pixel skipping process for the purpose of forming a whole image 53 with a less data amount. In the image cropping process, a part 36a of the image 36 is cropped out of the original data to form a detailed image 54 which has higher resolution than the whole image 53. The size of the detailed image 54 is determined in advance, and the image 36 is cropped out in that size when a cropping area is designated as described later. The whole image 53 corresponds to a first image of the present invention, and the second image 54 corresponds to a second image thereof.

In a case where after a detailed image 54 is delivered, there is a delivery request of an area peripheral to the detailed image 54, the image processing section 41b crops a new detailed image 54 in such a manner that the boundary of the new detailed image 54 overlaps that of the previous detailed image 54. Thus, the peripheral area of the detailed image 54 is easily legible. The request processing section 41a delivers the whole image 53 and the detailed image 54 to the portable terminal 22.

The whole image 53 is used for displaying the whole of the image 36 on the screen 22a of the portable terminal 22, and the detailed image 54 is used for displaying the part 36a of the image 36 with magnification. Accordingly, reduction in a data amount shortens the process time of the portable terminal 22, as compared with downloading and displaying the original data on the portable terminal 22.

In delivering the whole image 53 and the detailed image 54, the request processing section 41a generates coordinates data for identifying the position of the images 53 and 54 with respect to the image 36, and delivers the coordinates data together with the images 53 and 54. The coordinates data is useful for identifying the position of a peripheral area or a magnified area in such cases where a detailed image 54 has been displayed and then another detailed image 54 peripheral to the previous one is required, and the whole image 53 has been displayed and the detailed image 54 magnifying a part thereof is required. The browser 22c identifies the coordinates data of a desired display area designated by the radiologist 21 with the operation of the portable terminal 22. The browser 22c sends the coordinates data to the request processing section 41a, and downloads corresponding detailed image data.

The browser 22c generates the display screen 56 shown in FIG. 7 on the basis of the screen creation data 51 provided by the request processing section 41a, and displays it on the screen 22a. There are four types of display screen 56, that is, a patient information display screen 56a for displaying the basic patient information and annotation, an image list screen 56b for displaying a list of the images 36 to be interpreted, a whole image display screen 56c for displaying the whole image 53 and a detailed image display screen 56d for displaying the detailed image 54. The GUI for inputting operation commands are displayed under each of the screens 56a to 56d. The operational function of the GUI is assigned to a multi-function key (cross key or the like) and dial buttons of “0” to “9” in an operation panel 22d (refer to FIG. 6). The GUI in the display screen 56 functions as screen switching buttons 57 for switching a screen displayed on the screen 22a to any of the other four screens including the report edit screen 61.

The screen switching buttons 57 include a patient info button for switching to the patient information display screen 56a, an image list button for switching to the image list screen 56b, a whole image button for switching to the whole image display screen 56c, a detailed image button for switching to the detailed image display screen 56d and an edit button for turning from the display screen 56 to the report edit screen 61. Upon pressing any screen switching button 57, the browser 22c issues a request for the screen creation data 51 of the screen corresponding to the chosen button to the request processing section 41a, and generates the display screen 56 by the downloaded screen creation data 51.

The screen switching button 57 that corresponds to the screen being displayed on the screen 22a disappears, while the other four buttons for switching to the other screens appear. Taking the case of the patient information display screen 56a displayed on the screen 22a as an example, the patient info button disappears though the image list button, the whole image button, the detailed image button and the edit button appear.

Adopting the GUI makes it possible to easily and quickly switch from one screen to another as indicated by arrows in FIG. 7 no matter which screen 56a to 56d has been displayed, as compared with the case of, for example, cyclically switching a plurality of screens by a single screen switching button.

Data displayed on the patient information display screen 56a is obtained from the application data stored in the application database 32. The image list screen 56b is a screen which displays a list of a plurality of images 36 corresponding to the single image-interpretation request stored in the image database 33, and a plurality of selection buttons 58 are arranged thereon in accordance with each image 36. On the selection button 58 are displayed the image ID number, the body part (such as head, chest and stomach) and the like of the image 36. Information about the image ID number and body part is read out of the additional information of the image 36.

An asterisk 59 is a discrimination mark for discriminating the image 36 which the client wants the radiologist 21 to interpret with more careful attention than the others. When the client writes a specific image ID number on an “Annotation” field in an application, the asterisk 59 is tagged to the image 36. The asterisk 59 is an example of the discrimination mark, and the shape thereof is changeable. Also, other means are available as long as a specific image is discriminated, such as making the color, brightness or the like of the selection button 58 differ from the others.

When one selection button 58 is chosen in the image list screen 56b, a delivery request of the chosen image 36 is sent to the request processing section 41a. The request processing section 41a sends a whole image 53 of the requested image 36. No sooner is the whole image 53 downloaded, than display on the screen 22a automatically switches to the whole image display screen 56c to show the whole image 53.

In the whole image display screen 56c, the dial buttons of the operation panel 22d have the function of designating an area of a part of the whole image 53. Taking the operation panel 22d having the dial buttons of “1” to “9” arranged in a matrix with 3 rows and 3 columns with “5” sitting at the center thereof as an example, the dial button of “5” has the function of designating a central area of the screen. The other dial buttons surrounding “5” have the function of designating areas above, below, right, left and diagonal to the central area. For example, pressing “5” designates the central area of the whole image 53. If the dial button of “2” sits directly above “5”, pressing “2” designates the area above the central area. Pressing the dial button peripheral to “5” designates the area above, below, right, left or diagonal to the central area in a like manner.

When an area in the whole image 53 is designated by pressing the dial button, the browser 22c issues a delivery request of the detailed image 54 of that area to the request processing section 41a. The delivery request includes coordinates data of the designated area. As soon as the request processing section 41a receives the delivery request, the image processing section 41b crops the designated area out of the original image 36, and forms and delivers the detailed image 54. When the detailed image 54 has been delivered, display of the screen 22a automatically switches from the whole image display screen 56c to the detailed image display screen 56d to show the detailed image 54.

In the detailed image display screen 56d, the dial buttons have the function of designating areas peripheral to the displayed detailed image 54 in above, below, right, left and diagonal directions. When a peripheral area is designated by a press of the dial button, the browser 22c issues a delivery request of a peripheral image in the designated direction (including coordinates data), so that the request processing section 41c delivers the corresponding detailed image 54 in response thereto.

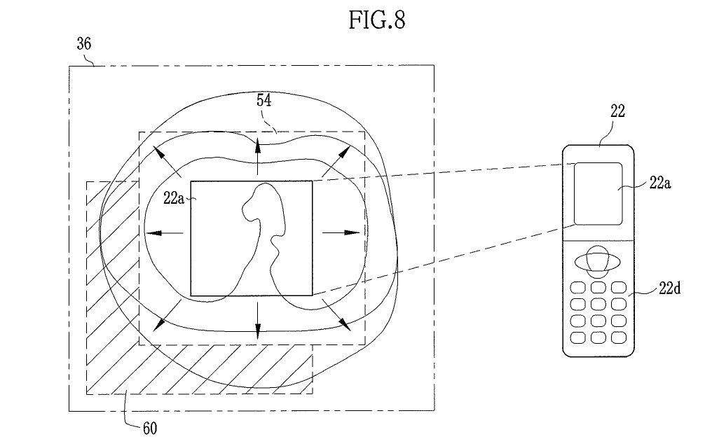

As shown in FIG. 8, the detailed image 54 is cropped out in a size larger than the size of the screen 22a. The browser 22c displays the detailed image 54 with the so-called virtual display technology by which the whole of the received detailed image 54 has been drawn in a display memory and only an area of size suited to the screen size is displayed on the screen 22a. According to this technology, when a peripheral area is designated by a press of the dial button, a detailed image of the peripheral area has already been drawn in the display memory, so that the detailed image in the display memory is quickly displayed on the screen 22a by just a scroll process without issuing a delivery request to the request processing section 41a. Thus, it is possible to quickly display the detailed image 54.

Also, when a peripheral area has been designated by a press of the dial button, the browser 22a forecasts the direction of a next designation and issues a delivery request of a next peripheral detailed image to the request processing section 41a. This process is written in an applet (asynchronous communication program) contained in the screen creation data 51, and the browser 22c runs the applet. To write the asynchronous communication program, for example, Ajax (Asynchronous JavaScript (trademark)+XML) is used.

The process of the asynchronous communication program is as follows. Taking a case where a part of a detailed image 54 in a central area of an image 36 has been displayed as shown in FIG. 8 as an example, assuming that a lower left peripheral area is designated by the dial button. At this time, the browser 22c scrolls the screen 22a in a lower left direction and displays the lower left part of the image 54, which has already been drawn in the display memory.

Then, if a further lower left peripheral area has been designated by another press of the dial button, the browser 22c issues a delivery request of the detailed image 54 of a further peripheral area 60 to the request processing section 41a. Even if there is no designation operation, on the other hand, the browser 22c forecasts such a designation and issues the delivery request of the detailed image 54 of the further peripheral area 60 by the asynchronous communication program. The browser 22c communicates with the request processing section 41a asynchronously to the peripheral area designation operation, and downloads the peripheral detailed image 54 in advance of the designation. Thus, it is possible to further quickly display the detailed image 54 on the screen 22a.

In either of the whole image display screen 56c and the detailed image display screen 56d, it is possible to electronically zoom in or out the displayed image. Electronic zooming process operation is assigned to the cross key or the like in the operation panel 22d.

The screen creation data 51 also generates the report edit screen 61 shown in FIG. 9 as with the display screen 56. The report edit screen 61 for making the simple-format report 38 is provided with a text-entry field 61a for inputting text. Under the text-entry field 61a, a GUI including a mode switching button 61b and an exit button 61c are provided.

The mode switching button 61b switches between two display modes, that is, a text-entry field display mode in which the text-entry field 61a is displayed in the report edit screen 61 by itself (refer to a lower half of FIG. 9) and a tiled display mode in which the text-entry field 61a and an image display field 61d are displayed in a tiled manner (refer to an upper half thereof). In the image display field 61d, the whole image 53 or the detailed image 54 is displayed. Switching between the two display modes allows creative use of the report edit screen 61 in such a manner that the tiled display mode is used in inputting text with observing the image and the text-entry field display mode is used in elaborating the inputted text. Therefore, it is possible to efficiently edit a report.

In the image display field 61d, for example, is displayed the whole image 53 or the detailed image 54 which has been displayed in the whole image display screen 56c or the detailed image display screen 56d just before calling up the edit screen 61. The GUI in the report edit screen 61 may be provided with an image switching button for switching between the whole image 53 and the detailed image 54 displayed in the image display field 61d. The exit button 61c is chosen to complete report editing. No sooner is the exit button 61c chosen, than the report edit screen 61 returns to the next previous display screen 56.

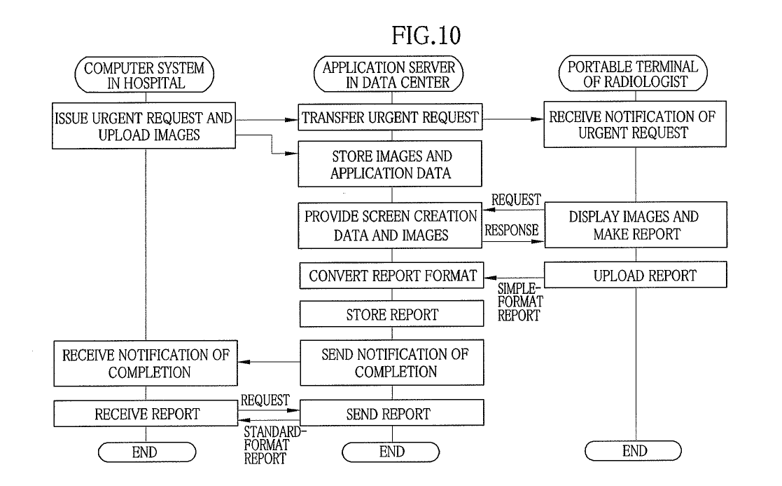

The operation of the foregoing image-interpretation service will be described with referring to a flowchart of FIG. 10. When the client terminal 16 of the hospital 12 issues an urgent image-interpretation request, the application server 28 accepts application data and uploaded medical images 36 and stores them in the application database 32 and the image database 33, respectively. The application server 28, as shown in FIG. 4, sends an urgent request notification to the image-interpretation center 14. In a case where the image-interpretation center 14 cannot deal with the urgent request, the image-interpretation center 14 sends a transfer order to the application server 28. Upon receiving the transfer order, the application server 28 transfers the urgent request notification to the portable terminal 22.

In receiving the notification by the portable terminal 22, the radiologist 21 accesses a delivery site of the application server 28 on the basis of an URL written in the notification. The application server 28 provides the screen creation data 51, whole images 53 and detailed images 54 in response to data delivery requests from the portable terminal 22. In the portable terminal 22, the browser 22c generates the display screen 56 and the report edit screen 61 by analyzing the screen creation data 51, and displays them on the screen 22a.

The patient information display screen 56a shows basic patient information and an annotation. The image list screen 56b shows a list of the images to be interpreted. In the image list screen 56b, the image 36 which a client wants the radiologist 21 to interpret prior to the other ones is indicated with the asterisk 59, so that the radiologist 21 can easily and clearly grasp client's intention. When one image 36 is chosen in the image list screen 56b, the portable terminal 22 issues a delivery request of the chosen image 36 to the application server 28.

In the application server 28, as shown in FIG. 5, the original data of the chosen image 36 is read out of the image database 33. The image processing section 41b subjects the original data to the data amount reduction process to form the whole image 53, and the request processing section 41a delivers the whole image 53 to the portable terminal 22. Upon receiving the whole image 53, the portable terminal 22 lays out the whole image 53 in the whole image display screen 56c and shows it on the screen 22a. Since the data amount of the whole image 53 is reduced as compared with the original data, communication time is shortened and the portable terminal 22 can display the image in short process time. Reduction in a process load contributes power saving too.

If the radiologist 21 designates a specific area by the operation panel 22d while the whole image display screen 56c is displayed, the browser 22c issues a delivery request of the detailed image 54 of the designated area. In the application server 28, the request processing section 41a identifies the designated area by coordinates data included in the delivery request, and the image processing section 41b crops data corresponding to the area out of the original data to form the detailed image 54. The request processing section 41a delivers the detailed image 54 to the portable terminal 22.

The portable terminal 22 lays out the received detailed image 54 in the detailed image display screen 56d and shows it on the screen 22a. Since the detailed image 54 is a part of the original image 36, the data amount of the detailed image 54 is smaller than that of the original image 36. Accordingly, the detailed image 54 is transferred in a short time and takes short time to perform a display process on the portable terminal 22. Furthermore, since the detailed image 54 is cropped out of the original image, the detailed image 54 has higher resolution than the whole image 53 with a reduced data amount. Thus, it is possible for the radiologist 21 to observe a minute portion of the image 36 in detail and precisely check a shadow of a lesion and the like.

While displaying the detailed image display screen 56d on the screen 22a, if the radiologist 21 designates a peripheral area by the operation panel 22d, the detailed image 54 is scrolled in such a direction. When the peripheral area has been designated, the portable terminal 22 obtains a detailed image of the further peripheral area 60, which is expected to be requested next time in accordance with a designation direction, from the application server 28 by the asynchronous communication program. This operation facilitates to shorten the display process time of a next displayed detailed image 54.

In image-interpretation operation, the radiologist 21 checks the whole or parts of the image 36 with switching between the whole image display screen 56c and the detailed image display screen 56d to zoom in and out on the displayed image 36. If there is a plurality of images 36, similar operation is carried out on an image basis. The application server 28 reduces the data amount of the whole image 53 and, as for the detailed image 54, crops out a part of the original image. Thus, alleviating a display process load on the portable terminal 22 allows an inexpensive terminal with limited capability to carry out image-interpretation without any problem. In addition, the radiologist 21 can observe a minute portion of the image 36 with great precision because the detailed image 54 has higher resolution than the whole image 53.

The radiologist 21 inputs an image-interpretation result on the report edit screen 61 in a textual format. In the report edit screen 61, the text-entry field display mode and the tiled display mode are switchable as the situation demands, so that it is possible for the radiologist 21 to efficiently edit a report. When the report is completely edited, the data of a simple-format report 38 is created. The portable terminal 22 uploads the simple-format report 38 to the application server 28.

In the application server 28, the report format converter 41c converts the received simple-format report 38 into the standard-format report 37. The simple-format report 38 and the standard-format report 37 are stored in the report database 34 in association with each other. After the reports 37 and 38 are stored, the application server 28 sends a report completion notification to the client terminal 16 of the hospital 12.

In receiving the notification, a doctor of the hospital 12 accesses the application server 28 on the basis of a URL written in the notification to download the standard-format report 37. Even if the portable terminal 22 has created the simple-format report 38, the client terminal 16 can receive the converted standard-format report 37. Accordingly, additional operational complication and additional cost, for example, to install a new application specific for displaying the simple-format report 38 does not occur.

In the foregoing embodiment, a first image according to the present invention refers to a whole image which shows the whole field of an original image to be interpreted. A second image refers to a detailed image which shows a part of the original image. As for the second image, data cropped out of the original image is delivered without being subjected to the data amount reduction process, but the present invention is not limited to it. For example, the first image may not be the whole image as long as it has a larger image field than the second image. Instead of using an image cropped out of the original image, the second image maybe subjected to the data amount reduction process to the extent of ensuring higher resolution than the first image.

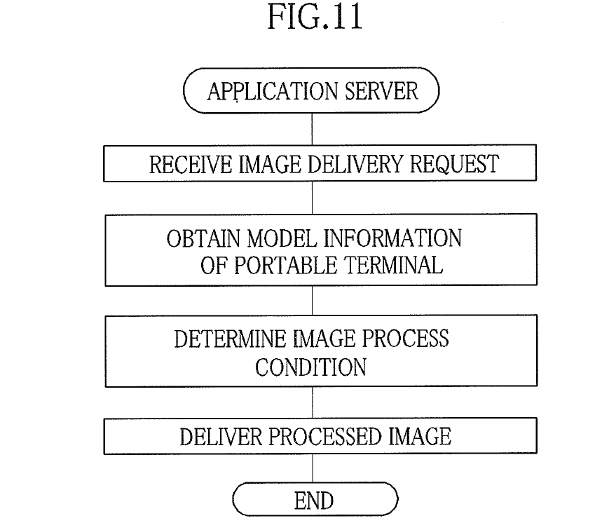

As shown in FIG. 11, the application server may determine image process conditions such as a data reduction rate of the whole image in the data amount reduction process, the cropping size of the detailed image in the cropping process and the like on the basis of model information issued by the portable terminal. The screen size and display processing capability vary among models of portable terminals. To a portable terminal having relatively high display performance and a large screen, are delivered a whole image with a low data reduction rate and a detailed image of a large size. To a portable terminal having relatively low display performance and a small screen, on the contrary, are delivered a whole image with a high data reduction rate and a detailed image of a small size. Properly determining the data reduction rate and cropping size in accordance with the model of the portable terminal makes full use of the performance of every portable terminal.

The foregoing embodiments describe examples of the display screen and the report edit screen. The contents of the GUI, function assignment to the operation panel and the like are properly changeable. For example, the operation panel has the function of designating an area in the foregoing embodiment, but the GUI may be provided with a direction designation button for designating the area.

The portable terminal is the cellular phone in the foregoing embodiment, but may be a PDA (personal digital assistant) or the like.

In the foregoing embodiment, the clerk of the image-interpretation center manually judges whether or not to issue a transfer order of an urgent image-interpretation request to the portable terminal, but the reception server may judge it instead. In such a case, for example, the schedule data of radiologists are stored in the reception server. Upon receiving an urgent request notification, the reception server judges whether or not a transfer order is necessary with referring to the schedule data. If yes, the reception server sends a transfer order with the mail address of the portable terminal of the radiologist to the data center.

Although the request is not urgent, when the radiologist designated by the client is out of the image-interpretation center, a transfer order may be issued to transfer the request to the portable terminal of the designated radiologist. Furthermore, the application server of the data center may manage the schedule data of radiologists and judge whether or not to transfer the request to the portable terminal. Instead of the application server managing the schedule data, the schedule data may be stored in the reception server of the image-interpretation center, and the application server may online access the reception server via the WAN to obtain the schedule data.

In the foregoing embodiment, the application server which delivers the images to the portable terminal is set up in the data center. Instead the image-interpretation center may have the application server and directly accept an image-interpretation request from the hospitals and clinic.

In the foregoing embodiment, the medical network system is composed of the computer systems set up in the plural medical facilities as the clients and the computer system in the data center which delivers the application data and images to be interpreted from the client to the request contact, but this invention is applicable to other embodiments. For example, a hospital has a plurality of sites, and each site has a role as a client, request contact or data center. Connecting a plurality of computer systems of every site with a network may configure a medical network system. Otherwise, connecting computer systems of a plurality of hospitals may configure a medical network system. In this case, any hospital has a role as a data center and functions as a host. In any case above, either WAN or LAN is available as a network for connecting the computer systems.

An image-interpretation apparatus according to the present invention may be composed of a computer system which is composed of a single server as the application server, or a computer system which distributes processing over a number of servers.

As described in the foregoing embodiment, the present invention extends to the configuration of a program and furthermore a recording medium for storing the program as a matter of course. In addition, the image database may be storage (memory) for storing a plurality of images.

Although the present invention has been fully described by the way of the preferred embodiment thereof with reference to the accompanying drawings, various changes and modifications will be apparent to those having skill in this field. Therefore, unless otherwise these changes and modifications depart from the scope of the present invention, they should be construed as included therein.

What is claimed is:

1. An image-interpretation support apparatus for supporting image-interpretation of a medical image by delivering a processed image to a portable terminal via a network, said image-interpretation support apparatus comprising:
an image obtaining section for obtaining data of said medical image from image storage;
a first image generator for forming a first image by reducing the data amount of said medical image;
a second image generator for forming a second image having higher resolution than said first image by cropping an area corresponding to a part of said first image out of said medical image; and
a delivery section for delivering said first image and said second image to said portable terminal.

2. The image-interpretation support apparatus recited in claim 1, wherein a field of said first image is the same as that of said medical image.

3. The image-interpretation support apparatus recited in claim 2, wherein said delivery section delivers a list of a plurality of said medical images to said portable terminal, and then delivers said first image of said medical image chosen from said list to said portable terminal.

4. The image-interpretation support apparatus recited in claim 3, wherein said medical image which is desired to be interpreted prior to the other of said medical images is marked with a distinction mark in said list.

5. The image-interpretation support apparatus recited in claim 3, wherein said delivery section delivers display screen creation data for displaying at least one of said first image, said second image and said list on a screen of said portable terminal.

6. The image-interpretation support apparatus recited in claim 5, wherein said display screen creation data includes an asynchronous communication program run on said portable terminal to issue a delivery request of said second image asynchronously to an input of an operational command to said portable terminal.

7. The image-interpretation support apparatus recited in claim 6, wherein said asynchronous communication program issues a delivery request of an image peripheral to said second image displayed on said screen of said portable terminal.

8. The image-interpretation support apparatus recited in claim 1, wherein said delivery section delivers report edit screen creation data for displaying a report edit screen of a medical report on a screen of said portable terminal.

9. The image-interpretation support apparatus recited in claim 8 further comprising:
a report format converter which receives data of said medical report inputted in said report edit screen and converts a format of said medical report into a predetermined report format.

10. The image-interpretation support apparatus recited in claim 8, wherein a text-entry field for inputting text and an image display field for displaying said first image or said second image are displayed in a tiled manner in said report edit screen.

11. The image-interpretation support apparatus as recited in claim 10, wherein said report edit screen has a graphic user interface for switching between a tiled display mode and a text-entry field display mode, both of said text-entry field and said image display field are displayed in said tiled manner in said tiled display mode and said text-entry field is displayed by itself in said text-entry field display mode.

12. A method for supporting an interpretation of a medical image by delivering a processed image to a portable terminal via a network, said method comprising the steps of:
obtaining data of said medical image from image storage;
forming a first image by reducing the data amount of said medical image;
forming a second image having higher resolution than said first image by cropping an area corresponding to a part of said first image out of said medical image; and
delivering said first image and said second image to said portable terminal.

13. A medical network system having a first computer system as an interpretation client of a medical image and a second computer system communicatably connected to said first computer system via a network for delivering a processed image to a portable terminal, said second computer system comprising:
an image obtaining section for obtaining data of said medical image from said first computer system;
a first image converter for forming a first image by reducing the data amount of said medical image;
a second image converter for forming a second image having higher resolution than said first image by cropping an area corresponding to a part of said first image out of said medical image; and
a delivery section for delivering said first image and said second image to said portable terminal.

14. The medical network system as recited in claim 13, wherein said second computer system further comprising:
a notification section for notifying said portable terminal about an image-interpretation request accepted from said first computer system.

15. The medical network system as recited in claim 14, wherein said notification section notifies a request contact different from said portable terminal of said image-interpretation request before notifying said portable terminal, and then notifies said portable terminal of said image-interpretation request on the basis of a response result from said request contact.
